(19) United States
(12) Patent Application Publication
(10) Pub. No.: US 2025/0263048 A1
(43) Pub. Date: Aug. 21, 2025

(54) MIDDLE BLADE STRUCTURE OF WIPER AND WIPER DEVICE

(71) Applicant: DANYANG UPC AUTO PARTS CO., LTD., DANYANG (CN)

(72) Inventors: Che-Wei CHANG, New Taipei City (TW); Cheng-Kai YANG, New Taipei City (TW); Chuan-Chih CHANG, New Taipei City (TW)

(21) Appl. No.: 18/444,661

(22) Filed: Feb. 17, 2024

(51) Int. Cl. B60S 1/38

(52) U.S. Cl. CPC B60S 1/3801; B60S 2001/3843

(57) ABSTRACT

A middle blade structure of a wiper includes a pivot plate and an outer arm. The pivot plate includes a pivot part disposed thereon. The pivot part includes a first inner arm extended from one end thereof, the first inner arm includes a fixed hole defined thereon, the pivot part including a second inner arm extended from another end thereof, a length of the second inner arm is shorter than a length of the first inner arm, the second inner arm including a bent part disposed on one end thereof, wherein the pivot part, the first inner arm, and the second inner arm are arranged on a same straight line. The outer arm, extended from the bent part, and including a connection part disposed on one end thereof, the connection part including a connection hole defined thereon.

### BACKGROUND OF THE DISCLOSURE

### Technical Field

The present disclosure relates to a wiper structure, particularly relates to a wiper structure installed on a vehicle.

### Description of Related Art

It is known that driving is currently the most convenient and high mobility way to go to work, do errands, travel, or shop. However, besides the car's battery being out of power and the water tank being out of the water, the most troublesome thing when driving is that the windshield wipers are not useful when it rains. Other than the surface of the windshield is difficult to be cleaned due to too many dust or oil stains, the reason why the wiper may not clean the car's windshield is that the material of the wiper blade (wiper rubber blade) is deteriorated and may not clean the dust and oil stains on the windshield. In this case, the driver may need to replace the wipers.

Due to the poor structural design of the wiper, the downward pressure of the wiper is insufficient and may not wipe the windshield cleanly. On the other hand, if the downward pressure is excessive, a loud frictional sound may be generated, or in severe cases, the wiper may jump during the brushing process.

Therefore, how to improve the design of the wiper structure so that the downward pressure of the wiper structure may not be insufficient or excessive during the brushing process, or cause jumping, is the current problems that need to be solved in this disclosure.

### SUMMARY OF THE DISCLOSURE

Therefore, the main purpose of the present disclosure is to solve the deficiency of the related-art. The present disclosure redesigns a middle blade structure of one of the accessories in a wiper structure and adopts a single-sided bending design to make the middle blade structure free from the problems of insufficient or excessive downward pressure to not only wipe the windshield clean but also free from jumping during the brushing process of the wiper structure.

To achieve the above purpose, the present disclosure provides a middle blade structure of a wiper, the middle blade structure including: a pivot plate and an outer arm. The pivot plate, including a pivot part disposed thereon, the pivot part including a first inner arm extended from one end thereof, the first inner arm including a fixed hole defined thereon, the pivot part including a second inner arm extended from another end thereof, a length of the second inner arm is shorter than a length of the first inner arm, the second inner arm including a bent part disposed on one end thereof. The pivot part, the first inner arm, and the second inner arm are arranged on a same straight line. The outer arm, extended from the bent part, and including a connection part disposed on one end thereof, the connection part including a connection hole defined thereon. An inner angle of the bent part between the pivot plate and the outer arm is between 120 degrees and 180 degrees.

In some embodiments, the middle blade structure, further including: a protruding part, disposed on a surface of the outer arm, a surface of the second inner arm, and a surface of the first inner arm.

To achieve the above purpose, the present disclosure also provides a wiper device, including: a middle blade structure, the middle blade structure, including: a pivot plate, and an outer arm. The pivot plate, including a pivot part disposed thereon, the pivot part including a first inner arm extended from one end thereof, the first inner arm including a fixed hole defined thereon, the pivot part including a second inner arm extended from another end thereof, a length of the second inner arm is shorter than a length of the first inner arm, the second inner arm including a bent part disposed on one end thereof. The pivot part, the first inner arm, and the second inner arm are arranged on a same straight line. The outer arm, extended from the bent part, and including a connection part disposed on one end thereof, the connection part including a connection hole defined thereon. An inner angle of the bent part between the pivot plate and the outer arm is between 120 degrees and 180 degrees.

In some embodiments, the pivot part includes a plurality of assembling grooves symmetrically disposed on two sides thereof.

In some embodiments, the assembling grooves are connected with a pivot component, the pivot component includes two bases, and each of the two bases includes a clamping channel, the clamping channel clamps the assembling groove of the pivot part; and the two bases respectively include a pivot hole communicating with each other, the middle blade structure is pivotally connected with a large blade structure through the pivot hole.

In some embodiments, the large blade structure includes a connecting through hole connected to a connection device, the connection device is connected with a wiper handle of a vehicle; and two connection arms are symmetrically extended from two ends of the connecting through hole, each of the connection arms includes a perforation defined thereon, a pivot axle passes through the perforation to be pivotally connected to the pivot hole of the pivot component to make the large blade structure be pivotally connected to the middle blade structure.

In some embodiments, a wiper cover is disposed on the large blade structure, the wiper cover includes a through hole defined thereon to expose the connection device, and two cover plates are extended from two ends of the through hole.

In some embodiments, the middle blade structure includes a protruding part, respectively disposed on a surface of the outer arm, the second inner arm, and the first inner arm.

In some embodiments, a fastener passes through the fixed hole and the connection hole to be fixed on a plurality of wing feet, each of the wing feet includes a beam arm in an arc shape, and the beam arm includes two claw parts disposed on two ends thereof, the claw parts are assembled on a wiper blade.

In some embodiments, the wiper blade includes a main body, the main body is in a long strip shape, and includes an assembly part and a scraping strip, the assembly part includes two grooves respectively disposed on two side faces thereof, and the grooves are connected with the claw parts.

### BRIEF DESCRIPTION OF THE DRAWINGS

FIG. 1 is a schematic diagram of the appearance of the middle blade structure of the wiper device in accordance with the present disclosure;

FIG. 2 is a side-view schematic diagram of the middle blade structure of FIG. 1;

FIG. 3 is a structurally exploded diagram of the wiper device in accordance with the present disclosure;

FIG. 4 is a partially enlarged side-view diagram of FIG. 3.

### DETAILED DESCRIPTION

The technical contents of this disclosure will become apparent with the detailed description of embodiments accompanied with the illustration of related drawings as follows. It is intended that the embodiments and drawings disclosed herein are to be considered illustrative rather than restrictive.

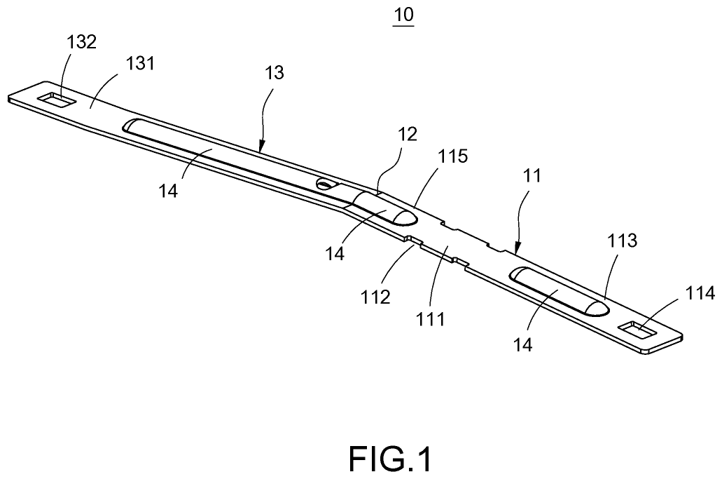

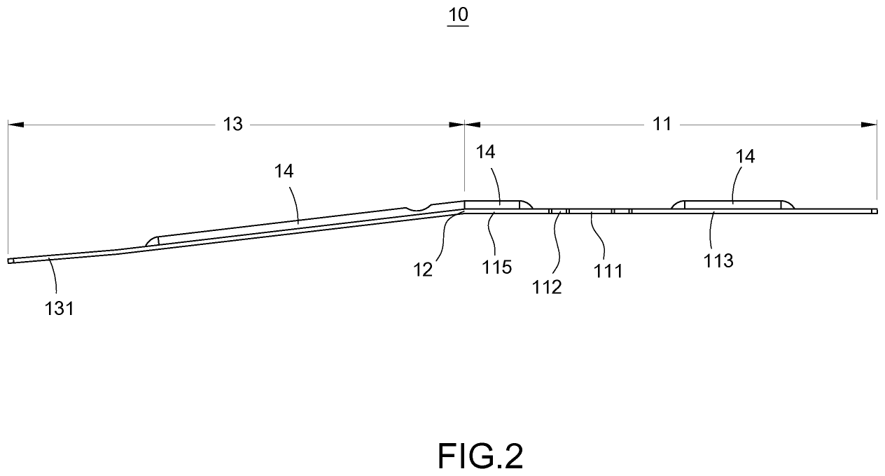

FIG. 1 is a schematic diagram of the appearance of the middle blade structure 10 of the wiper device in accordance with the present disclosure, FIG. 2 is a side-view schematic diagram of the middle blade structure 10 of FIG. 1, please refer to FIGS. 1 and 2. The present disclosure provides a middle blade structure 10 of a wiper, the middle blade structure 10 includes a pivot plate 11, an outer arm 13, and a protruding part 14. The pivot plate 11 and the outer arm 13 form the middle blade structure 10 of the wiper to be a single-sided bending design.

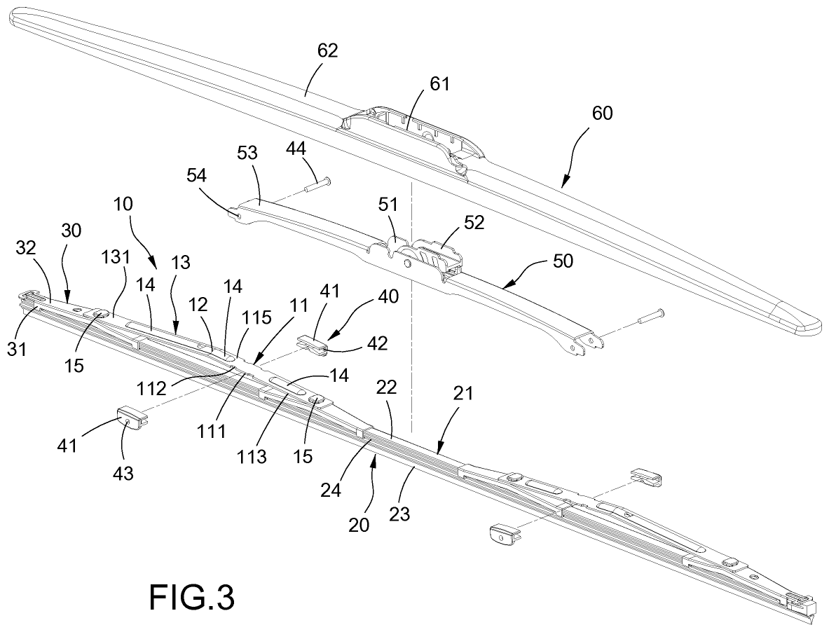

The pivot plate 11 includes a pivot part 111 disposed thereon, and the pivot part 111 includes a plurality of assembling grooves 112 symmetrically disposed on two sides thereof. The assembling grooves 112 are connected with a pivot component 40 (as shown in FIG. 3). The pivot part 111 includes a first inner arm 113 extended from one end thereof, and the first inner arm 113 includes a fixed hole 114 defined thereon. The middle blade structure 10 is fixed to the wing foot 30 through the fixed hole 114 (as shown in FIG. 3). The pivot part 111 includes a second inner arm 115 extended from another end thereof. A length of the second inner arm 115 is shorter than a length of the first inner arm 113. The second inner arm 115 includes a bent part 12 disposed on one end thereof. The pivot part 111, the first inner arm 113, and the second inner arm 115 are arranged on a same straight line.

The outer arm 13 is extended from the bent part 12 and includes a connection part 131 disposed on one end thereof. The connection part 131 includes a connection hole 132 defined thereon. The middle blade structure 10 is also fixed to the wing foot 30 through the connection part 131 (as shown in FIG. 3).

The protruding part 14 is disposed on a surface of the outer arm 13, a surface of the second inner arm 115, and a surface of the first inner arm 113. The protruding part 14 is used to strengthen the structure of the pivot plate 11 and the structure of the outer arm 13, so that the pivot plate 11 and the outer arm 13 are not easily to be deformed.

It is worth mentioning that, the inner angle of the bent part 12 between the pivot plate 11 and the outer arm 13 is between 120 degrees and 180 degrees. The single-sided bending design prevents the elastic pressure, that downward presses the wiper blade 20 (as shown in FIG. 2), from being too large. When the middle blade structure 10 is installed on the wiper structure and being used, the wiper blade 20 may not be downward pressed by excessive elastic pressure, and the friction coefficient between the wiper blade 20 and the windshield of the car may be decreased. Therefore, the quality of wiping the windshield (may be wipe clean) is increased, and the damage rate of the wiper blade 20 is decreased.

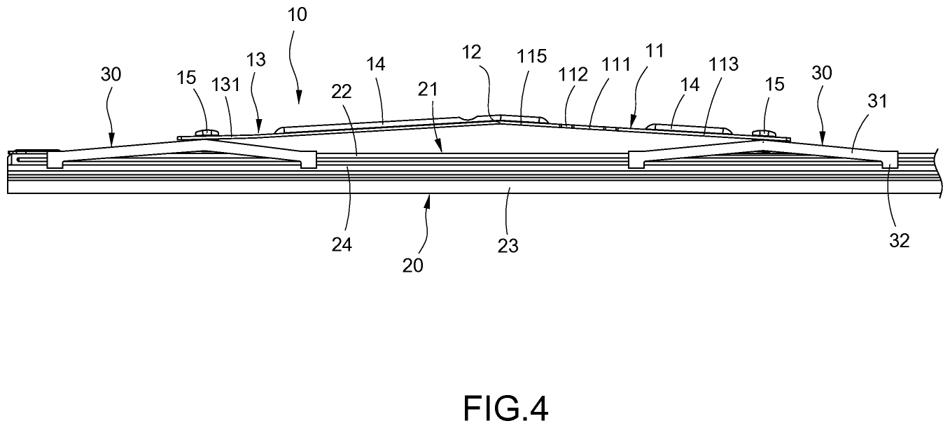

FIG. 3 is a structurally exploded diagram of the wiper device in accordance with the present disclosure, FIG. 4 is a partially enlarged side-view diagram of FIG. 3, please refer to FIGS. 3 and 4. The present disclosure of the wiper device includes two middle blade structures 10, a wiper blade 20, a plurality of wing feet 30, a plurality of pivot devices 40, a large blade structure 50, and a wiper cover 60.

The wiper blade 20 includes a main body 21, the main body 21 is in a long strip shape and includes an assembly part 22 and a scraping strip 23, the assembly part 22 includes two grooves 24 respectively disposed on two side faces thereof, the grooves 24 are connected with the claw parts 32. In this figure, the wiper blade 20 is made of rubber elastic material and may contact the windshield of the vehicle.

Each of the wing feet 30 includes a beam arm 31 in an arc shape, the beam arm 31 includes two claw parts 32 disposed on two ends thereof, the claw part 32 is assembled in the groove 24 of the assembly part 22, so that the claw parts 32 may firmly assemble on a wiper blade 20. Then, the fastener 15 passes through the fixed hole 114 and the connection hole 132 to be fixed on the beam arm 31 of the wing feet 30.

The assembling grooves 24 are connected with a pivot component 40, the pivot component 40 includes two bases 41, each of the two bases 41 includes a clamping channel 42, and the clamping channel 42 clamps the assembling groove 24 of the pivot part 111. The two bases 41 respectively include a pivot hole 43 communicating with each other, the middle blade structure 10 is pivotally connected with a large blade structure 50 through the pivot hole 43.

The large blade structure 50 includes a connecting through hole 51 connected to a connection device 52, the connection device 52 is connected with a wiper handle (not shown in figures) of a vehicle. Two connection arms 53 are symmetrically extended from two ends of the connecting through hole 51, each of the connection arms 53 includes a perforation 54 defined thereon, and a pivot axle passes through the perforation 54 to be pivotally connected to the pivot hole 43 of the pivot component 40 to make the large blade structure 50 be pivotally connected to the middle blade structure 10.

The wiper cover 60 includes a through hole 61 defined thereon to expose the connection device 52, and two cover plates 62 are extended from two ends of the through hole 61. The cover plate 62 may cover the large blade structure 50, the middle blade structure 10, the pivot device 40, the wing foot 30, and the wiper blade 20 to reduce the influence from the external environment for the large blade structure 50, the middle blade structure 10, the pivot device 40 and the wing foot 30, and the malfunction or damage for the structures may also be reduced.

Through the single-sided bending design of the middle blade structure 10 of the wiper in the present disclosure, insufficient or excessive downward pressure problems of the wiper structure or jumping during the brushing process of the wiper structure may be prevented, the damage to the wiper blade 20 may be greatly reduced and the service life of the wiper blade 20 may be extended.

In addition, since the middle blade structure 10 of the wiper in the present disclosure adopts a single-sided bending design. Comparing the present disclosure with the U.S. Pat. No. 11,180,118B2 patent (which is abbreviated as the prior-art), FIG. 6 of the prior-art discloses a secondary frame, the secondary frame adopts a bilateral asymmetrical bending design and includes a central pivot connection portion. The central pivot connection portion includes an outer leg and an inner leg extended from two ends thereof. Based on the central pivot connection portion, the descending and bending angle of the outer leg is equal to or less than the descending and bending angle of the inner leg to form an asymmetrical bending design as mentioned above.

In addition, the asymmetric bending design of the prior-art is more labor-intensive and time-consuming during production, and after being installed on the wiper handle of the car, when the wiper blade contacts with the windshield of the car, the secondary frame is prone to excessive downward pressure, and causing the wiper blade to be downward pressed by excessive elasticity. After using for a period time, the rubber material of the wiper blade is prone to be worn. This may cause a grinding sound or scratching on the windshield.

While this disclosure has been described by means of specific embodiments, numerous modifications and variations may be made thereto by those skilled in the art without departing from the scope and spirit of this disclosure set forth in the claims.

What is claimed is:

1. A middle blade structure of a wiper, the middle blade structure comprising:
a pivot plate, comprising a pivot part disposed thereon, the pivot part comprising a first inner arm extended from one end thereof, the first inner arm comprising a fixed hole defined thereon, the pivot part comprising a second inner arm extended from another end thereof, a length of the second inner arm is shorter than a length of the first inner arm, the second inner arm comprising a bent part disposed on one end thereof, wherein the pivot part, the first inner arm, and the second inner arm are arranged on a same straight line; and
an outer arm, extended from the bent part, and comprising a connection part disposed on one end thereof, the connection part comprising a connection hole defined thereon, wherein an inner angle of the bent part between the pivot plate and the outer arm is between 120 degrees and 180 degrees.

2. The middle blade structure of claim 1, further comprising:
a protruding part, disposed on a surface of the outer arm, a surface of the second inner arm, and a surface of the first inner arm.

3. A wiper device, comprising:
a middle blade structure, comprising:
a pivot plate, comprising a pivot part disposed thereon, the pivot part comprising a first inner arm extended from one end thereof, the first inner arm comprising a fixed hole defined thereon, the pivot part comprising a second inner arm extended from another end thereof, a length of the second inner arm is shorter than a length of the first inner arm, the second inner arm comprising a bent part disposed on one end thereof, wherein the pivot part, the first inner arm, and the second inner arm are arranged on a same straight line; and
an outer arm, extended from the bent part, and comprising a connection part disposed on one end thereof, the connection part comprising a connection hole defined thereon, wherein an inner angle of the bent part between the pivot plate and the outer arm is between 120 degrees and 180 degrees.

4. The wiper device of claim 3, wherein the pivot part comprises a plurality of assembling grooves symmetrically disposed on two sides thereof.

5. The wiper device of claim 4, wherein the assembling grooves are connected with a pivot component, the pivot component comprises two bases, each of the two bases comprises a clamping channel, the clamping channel clamps the assembling groove of the pivot part; and
the two bases respectively comprise a pivot hole communicating with each other, the middle blade structure is pivotally connected with a large blade structure through the pivot hole.

6. The wiper device of claim 5, wherein the large blade structure comprises a connecting through hole connected to a connection device, the connection device is connected with a wiper handle of a vehicle; and
two connection arms are symmetrically extended from two ends of the connecting through hole, each of the connection arms comprises a perforation defined thereon, and a pivot axle passes through the perforation to be pivotally connected to the pivot hole of the pivot component to make the large blade structure be pivotally connected to the middle blade structure.

7. The wiper device of claim 6, wherein a wiper cover is disposed on the large blade structure, the wiper cover comprises a through hole defined thereon to expose the connection device, and two cover plates are extended from two ends of the through hole.

8. The wiper device of claim 3, wherein the middle blade structure comprises a protruding part, respectively disposed on a surface of the outer arm, the second inner arm, and the first inner arm.

9. The wiper device of claim 3, wherein a fastener passes through the fixed hole and the connection hole to be fixed on a plurality of wing feet, each of the wing feet comprises a beam arm in an arc shape, the beam arm comprises two claw parts disposed on two ends thereof, the claw parts are assembled on a wiper blade.

10. The wiper device of claim 9, wherein the wiper blade comprises a main body, the main body is in a long strip shape and comprises an assembly part and a scraping strip, the assembly part comprises two grooves respectively disposed on two side faces thereof, the grooves are connected with the claw parts.
